(19) United States
(12) Patent Application Publication
(10) Pub. No.: US 2025/0147494 A1
(43) Pub. Date: May 8, 2025

(54) ASSEMBLY OPTIMIZATION METHOD, SYSTEM, AND MEDIUM BASED ON INDUSTRIAL INTERNET OF THINGS (IIOT)

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/015,594

(22) Filed: Jan. 9, 2025

(30) Foreign Application Priority Data
Dec. 5, 2024 (CN) 202411776330.X

(51) Int. Cl. G05B 19/418; G16Y 10/25

(52) U.S. Cl. CPC G05B 19/41865; G05B 19/41885; G16Y 10/25

(57) ABSTRACT

Disclosed is an assembly optimization method, system, and medium based on Industrial Internet of Things (IIoT). The assembly optimization method comprises: obtaining and uploading session assembly data of a production line; obtaining an initial assembly scheme; determining an optimized assembly scheme; determining a target assembly scheme; generating and storing an assembly regulation instruction; in response to an adjustment time being reached, sending an assembly regulation instruction to regulate a device operation parameter of a production device and a conveyor belt parameter of a conveyor belt; obtaining reference assembly data of the production line; in response to the reference assembly data meeting a correction condition: determining a correction optimization session of a current assembly scheme; generating a corrected assembly scheme; storing the corrected assembly scheme and generating a correction regulation instruction; and sending the correction regulation instruction to correct the device operation parameter and the conveyor belt parameter.

### CROSS-REFERENCE TO RELATED APPLICATIONS

This application claims priority to Chinese Application No. 202411776330.X, filed on Dec. 5, 2024, the entire contents of which are incorporated herein by reference.

### TECHNICAL FIELD

The present disclosure relates to the field of Industrial Internet of Things (IIoT) assembly, and in particular to an assembly optimization method, system, and medium based on IIoT.

### BACKGROUND

With the advancement of industrial intelligence, smart manufacturing has become an important direction for the digital transformation of manufacturing industry. As one of key technologies of smart manufacturing, Industrial Internet of Things (IIoT) integrates various technologies such as sensor technology, network communication, and big data analytics into various aspects of industrial production. The IIoT is capable of collecting a large amount of data in the process of industrial production in real time, carrying out data interactions between devices, and device and personnel, and helping production managers carry out intelligent management.

Product assembly manufacturing is an important part of product quality assurance. In traditional manufacturing processes, data collection primarily relies on manual collection or simple device monitoring, which often suffers from problems such as untimely and inaccurate data acquisition, lack of effective synchronization mechanisms between an assembly site and an information system, and lack of means of data analysis and application. As a result, the quality data in the assembly process is often dispersed in various sessions and departments and cannot be transmitted to the information system in time. In addition, fragmented and unsystematic data makes it difficult to analyze and improve quality problems. The production process and device state can be monitored in real time based on the IIoT, and device fault conditions can be diagnosed through the analysis and processing of the production process and device data, so as to implement intelligent maintenance. Meanwhile, potential production problems can be identified and solved based on the IIoT, thereby significantly improving production efficiency and enhancing product quality.

Therefore, it is desirable to provide an assembly optimization method based on the IIoT to improve the intelligent management of manufacturing industry.

### SUMMARY

One or more embodiments of the present disclosure provide an assembly optimization method based on Industrial Internet of Things (IIoT). The assembly optimization method may comprise: obtaining session assembly data of a production line through an IIoT perceptual control platform, and uploading the session assembly data to an IIoT management platform through an IIoT sensor network platform; obtaining an initial assembly scheme from a scheme database, the scheme database being stored in a data center of the IIoT management platform; determining an optimized assembly scheme based on the session assembly data and the initial assembly scheme; determining a target assembly scheme based on the optimized assembly scheme; generating an assembly regulation instruction based on the target assembly scheme; determining the target assembly scheme as a current assembly scheme and storing the current assembly scheme in the data center; in response to determining that an adjustment time is reached, sending the assembly regulation instruction to the IIoT perceptual control platform to regulate a device operation parameter of the production device and a conveyor belt parameter of a conveyor belt; obtaining, based on the IIoT perceptual control platform, reference assembly data of the production line after the assembly regulation instruction is implemeted; in response to determining that the reference assembly data meets a correction condition: determining a correction optimization session of the current assembly scheme; generating a corrected assembly scheme by correcting the current assembly scheme based on the correction optimization session; storing the corrected assembly scheme in the data center, and generating a correction regulation instruction based on the corrected assembly scheme; and sending the correction regulation instruction to the IIoT perceptual control platform to correct the device operation parameter of the production device and the conveyor belt parameter of the conveyor belt.

One or more embodiments of the present disclosure provide an assembly optimization system based on Industrial Internet of Things (IIoT). The assembly optimization system comprises: an IIoT user platform, an IIoT service platform, an IIoT management platform, an IIoT sensor network platform, and an IIoT perceptual control platform. The IIoT management platform is in communication with the IIoT sensor network platform and the IIoT service platform. The IIoT perceptual control platform may include a production device of a production line and a data collection device disposed on the production line. The IIoT perceptual control platform may realize data interaction with the IIoT management platform through the IIoT sensor network platform. The IIoT management platform may be configured to implement the assembly optimization method.

One or more embodiments of the present disclosure provide a non-transitory computer-readable storage medium comprising computer instructions that, when read by a computer, may direct the computer to perform the assembly optimization method.

In some embodiments of the present disclosure, by dynamically adjusting the assembly scheme, the adaptability and flexibility of the system is improved, problems in the actual production are discovered and corrected in time, and assembly errors and malfunctions are reduced. By continuously optimizing the assembly scheme, the overall performance and efficiency of the production line can be effectively enhanced, thereby ensuring the feasibility and reliability of the optimized assembly scheme and reducing production risks.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating a platform structure of IIoT according to some embodiments of the present disclosure;

FIG. 2 is a flowchart illustrating an exemplary assembly optimization method based on IIoT according to some embodiments of the present disclosure;

FIG. 3 is flowchart illustrating an exemplary process of determining an optimized assembly scheme according to some embodiments of the present disclosure;

FIG. 4 is a schematic diagram illustrating an exemplary parameter generation model according to some embodiments of the present disclosure; and

FIG. 5 is a flowchart illustrating an exemplary process of determining a target assembly scheme according to some embodiments of the present disclosure.

### DETAILED DESCRIPTION

The industrial production process can be optimized by developing a reasonable industrial assembly scheme based on the IIoT technology. Therefore, it is desirable to provide an assembly optimization method based on IIoT, which can perform optimization and simulation verification on the assembly scheme based on data collected through the IIoT and intelligent tools to ensure that the scheme is practicable and feasible, thereby further advancing the level of intelligent management of manufacturing industry.

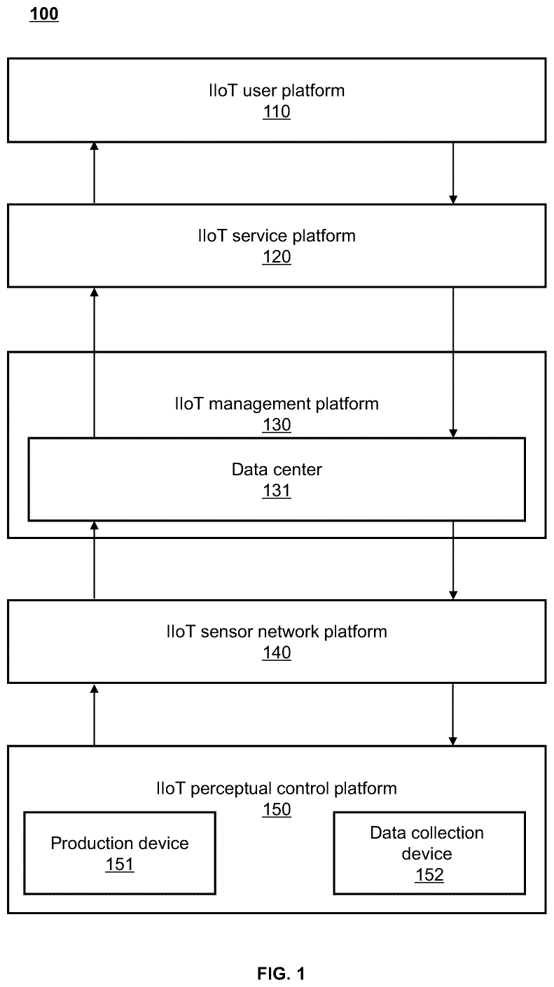

FIG. 1 is a schematic diagram illustrating a platform structure of IIoT according to some embodiments of the present disclosure.

In some embodiments, as shown in FIG. 1, an IIoT 100 includes an IIoT user platform 110, an IIoT service platform 120, an IIoT management platform 130, an IIoT sensor network platform 140, and an IIoT perceptual control platform 150.

The IIoT user platform 110 refers to a platform for interacting with IIoT users. In some embodiments, the IIoT user platform 110 may be configured as a terminal device.

In some embodiments, the IIoT user platform 110 may perform data interaction with the IIoT service platform 120.

The IIoT service platform 120 refers to a platform for data interaction with at least one of the IIoT user platform 110 or the IIoT management platform 130.

In some embodiments, the IIoT service platform 120 may be in communication with the IIoT management platform 130.

The IIoT management platform 130 refers to a platform for coordinating and managing the entire IIoT system. In some embodiments, the IIoT management platform 130 may be provided with a processor. The processor may perform data interaction with one or more platforms in the IIoT 100 (e.g., the IIoT service platform 120, the IIoT sensor network platform 140, or the like) and perform data processing. The processor may also generate and/or control execution of one or more program instructions in the present disclosure.

In some embodiments, the IIoT management platform 130 may be in communication with the IIoT sensor network platform 140 and the IIoT service platform 120.

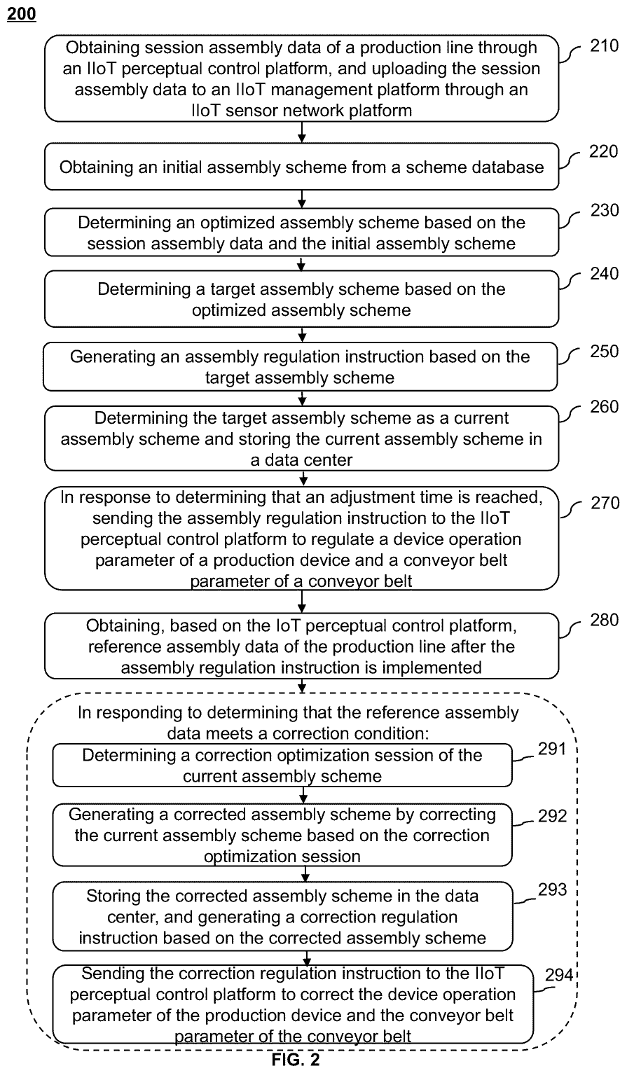

In some embodiments, the IIoT management platform 130 may perform data interaction with the IIoT perceptual control platform 150 through the IIoT sensor network platform 140. For example, the IIoT management platform 130 may generate an assembly regulation instruction and a correction regulation instruction, and send the assembly regulation instruction and the correction regulation instruction to the IIoT perceptual control platform 150 through the IIoT sensor network platform 140. More descriptions regarding the assembly regulation instruction and the correction regulation instruction may be found elsewhere in the present disclosure (e.g., FIG. 2 and related descriptions thereof).

In some embodiments, the IIoT management platform 130 may determine an optimized assembly scheme based on session assembly data and an initial assembly scheme; determine a target assembly scheme based on the optimized assembly scheme; generate the assembly regulation instruction based on the target assembly scheme; generate a corrected assembly scheme based on the correction optimization session; generate the correction regulation instruction based on the corrected assembly scheme. More descriptions may be found elsewhere in the present disclosure (e.g., FIG. 2 and related descriptions thereof).

In some embodiments, the IIoT management platform 130 may include a data center 131.

The data center 131 may be configured to store, manage, and transmit data.

In some embodiments, the data center 131 may store a scheme database and a plurality of schemes, such as the initial assembly scheme, the corrected assembly scheme, and the target assembly scheme obtained during implementation of the assembly optimization method. More descriptions regarding the scheme database, the initial assembly scheme, the corrected assembly scheme, and the target assembly scheme may be found elsewhere in the present disclosure (e.g., FIG. 2 and related descriptions thereof).

The IIoT sensor network platform 140 refers to an interface platform for realizing data interaction between the IIoT management platform 130 and the IIoT perceptual control platform 150.

In some embodiments, the IIoT sensor network platform 140 may be in communication with the IIoT management platform 130.

In some embodiments, the IIoT sensor network platform 140 may upload the session assembly data obtained by the IIoT perceptual control platform 150 to the IIoT management platform 130.

The IIoT perceptual control platform 150 refers to a platform for sensing information generation and controlling information execution.

In some embodiments, the IIoT perceptual control platform 150 may obtain the session assembly data of a production line and regulate a device operation parameter of a production device and a conveyor belt parameter of a conveyor belt.

In some embodiments, the IIoT perceptual control platform 150 may realize data interaction with the IIoT management platform 130 through the IIoT sensor network platform 140. For example, the IIoT perceptual control platform 150 may obtain the session assembly data of the production line in real time, and upload the session assembly data to the IIoT management platform 130 through the IIoT sensor network platform 140.

In some embodiments, the IIoT perceptual control platform 150 may include a production device 151 and a data collection device 152.

The production device 151 refers to a device used for production in each production session of the production line, such as an assembly device, a processing device, a testing device, or the like.

The data collection device 152 refers to a device for collecting the session assembly data of the production line.

In some embodiments, the data collection device may include at least one of a sensor, an RFID technology device, a scanning gun, a camera, or the like.

In some embodiments, the data collection device may collect various data, such as temperature data, humidity data, voltage and current data, pressure data, an RF signal, location and state of an item, environmental data, audio data, video data, or the like.

In some embodiments of the present disclosure, production management personnel can monitor an environmental state and a device operation state in real time through the various data collected by the data collection device, discover potential faults and risks in time, and prevent safety accidents in the production. In addition, the production management personnel can control parameters of the production device (e.g., an operation speed, a current, a voltage, a temperature, or the like), thereby ensuring product quality while efficiently allocating resources.

FIG. 2 is a flowchart illustrating an exemplary assembly optimization method based on IIoT according to some embodiments of the present disclosure.

In some embodiments, the assembly optimization method based on the IIoT may include: obtaining session assembly data of a production line through an IIoT perceptual control platform, and uploading the session assembly data to an IIoT management platform through an IIoT sensor network platform; obtaining an initial assembly scheme from a scheme database, the scheme database being stored in a data center of the IIoT management platform; determining an optimized assembly scheme based on the session assembly data and the initial assembly scheme; determining a target assembly scheme based on the optimized assembly scheme; generating an assembly regulation instruction based on the target assembly scheme; determining the target assembly scheme as a current assembly scheme and storing the current assembly scheme in the data center; in response to determining an adjustment time is reached, sending the assembly regulation instruction to the IIoT perceptual control platform to regulate a device operation parameter of the production device and a conveyor belt parameter of a conveyor belt; obtaining, based on the IIoT perceptual control platform, reference assembly data of the production line after the assembly regulation instruction is implemeted; in response to determining that the reference assembly data meets a correction condition: determining a correction optimization session of the current assembly scheme; generating a corrected assembly scheme by correcting the current assembly scheme based on the correction optimization session; storing the corrected assembly scheme in the data center, and generating a correction regulation instruction based on the corrected assembly scheme; and sending the correction regulation instruction to the IIoT perceptual control platform to correct the device operation parameter of the production device and the conveyor belt parameter of the conveyor belt.

As shown in FIG. 2, a process 200 may include the following operations. In some embodiments, the process 200 may be performed by the IIoT management platform.

In 210, session assembly data of a production line may be obtained through an IIoT perceptual control platform, and the session assembly data may be uploaded to an IIoT management platform through an IIoT sensor network platform.

More descriptions regarding the IIoT perceptual control platform, the IIoT sensor network platform, and the IIoT management platform may be found elsewhere in the present disclosure (e.g., FIG. 1 and the related descriptions thereof).

The production line refers to an ensemble of all assembly units required for assembling a product. In some embodiments, the production line may include a plurality of workstations. The plurality of workstations refer to device configurations for assembling parts or components in various sessions of the production line.

The session assembly data refers to data related to assembly in various sessions of the production line. For example, the session assembly data may include a model, a quantity, a position, an assembly time of a combined assembly part, an assembly action sequence of a person or a machine, feature data of a stage assembly component, a staging quantity at a staging location, or the like.

The assembly action sequence of the person or the machine refers to a sequence consisting of assembly operations when assembly is performed using manual labor or a machine.

The stage assembly component refers to a component that is assembled in each session of the production process. The feature data of the stage assembly component refers to data related to characterizing a components that is assembled in each session of the production process, such as image data, weight data, quality sampling data, or the like, of the stage assembly component.

In some embodiments, the session assembly data may be obtained by a data collection device of the IIoT perceptual control platform. More descriptions regarding the data collection device may be found elsewhere in the present disclosure (e.g., FIG. 1 and the related descriptions thereof).

In 220, an initial assembly scheme may be obtained from a scheme database.

In some embodiments, the scheme database may be stored in a data center of the IIoT management platform.

More descriptions regarding the data center may be found elsewhere in the present disclosure (e.g., FIG. 1 and the related descriptions thereof).

The scheme database refers to a database for storing assembly schemes.

The assembly scheme refers to a scheme for assembling parts or components into a complete product according to certain processes and methods. In some embodiments, the assembly scheme may include an assembly assistance parameter, an assembly sequence, an assembly time sequence, an assembly method sequence, an assembly part object sequence, a part list sequence, or the like.

The assembly assistance parameter refers to a relevant parameter that assists the assembly process to proceed. For example, the assembly assistance parameter may include, but is not limited to, a conveyor belt speed, a robotic arm movement speed, a torque setting, or the like. The torque setting refers to an associated setting for force and force arm of torque.

The assembly sequence refers to an order in which parts or components are assembled.

The assembly time sequnce refers to a sequence consisting of time required for assembling components of each session.

The assembly method sequence refers to a sequence of methods for assembling components of each session. For example, the assembly method sequence may include manual or automatic tools, assembly techniques, or the like, that are used for each session of the assembly.

The assembly part object sequence refers to a sequence of objects that need to be assembled at each workstation.

The part list sequence refers to a detailed list of all parts that need to be assembled in each session. For example, the parts list sequence may include a model, a specification, a quantity, or the like, of parts to be assembled.

The initial assembly scheme may be preset by staff based on experience.

In 230, an optimized assembly scheme may be determined based on the session assembly data and the initial assembly scheme.

The optimized assembly scheme refers to an assembly acheme that is obtained by optimizing the initial assembly scheme.

In some embodiments, the IIoT management platform may determine the optimized assembly scheme based on the session assembly data and the initial assembly scheme in various ways. For example, the IIoT management platform may obtain a plurality of optimized assembly schemes by adjusting one or more of the assembly assistance parameters, the assembly sequence, the assembly part object sequence, the assembly time, or the like, of the initial assembly scheme based on the session assembly data.

Adjusting of the assembly time may be implemented by adjusting an operation parameter of the each workstation. The operation parameter of the each workstation may include a transmission speed of the conveyor belt, an assembly speed of the each workstation, a manner of combining the parts, or the like. The manner of combining the parts refers to a manner of combining the parts assembled by the same workstation. For example, the initial assembly scheme of a certain workstation set for assembling a part A and a part B may be changed to assembling the part B and a part C.

Merely by way of example, the IIoT management platform may obtain the plurality of optimized assembly schemes by adjusting one or more of the assembly sequence, the operation parameter of the each workstation, the assembly speed, or the like, of the initial assembly scheme based on the session assembly data.

In some embodiments, during the adjustment process, the IIoT management platform may obtain the plurality of optimized assembly schemes by randomly adjusting one or more of assembly sessions to be adjusted.

The assembly sessions to be adjusted are sessions where a time difference ratio is greater than a preset ratio. The time difference ratio refers to a ratio of a difference between an actual assembly time and a preset assembly time to the preset assembly time.

The adjustment process may include increasing an assembly time of the assembly sessions to be adjusted. In some embodiments, a magnitude of adjusting the assembly time of the assembly sessions to be adjusted may be positively correlated with the time difference ratio.

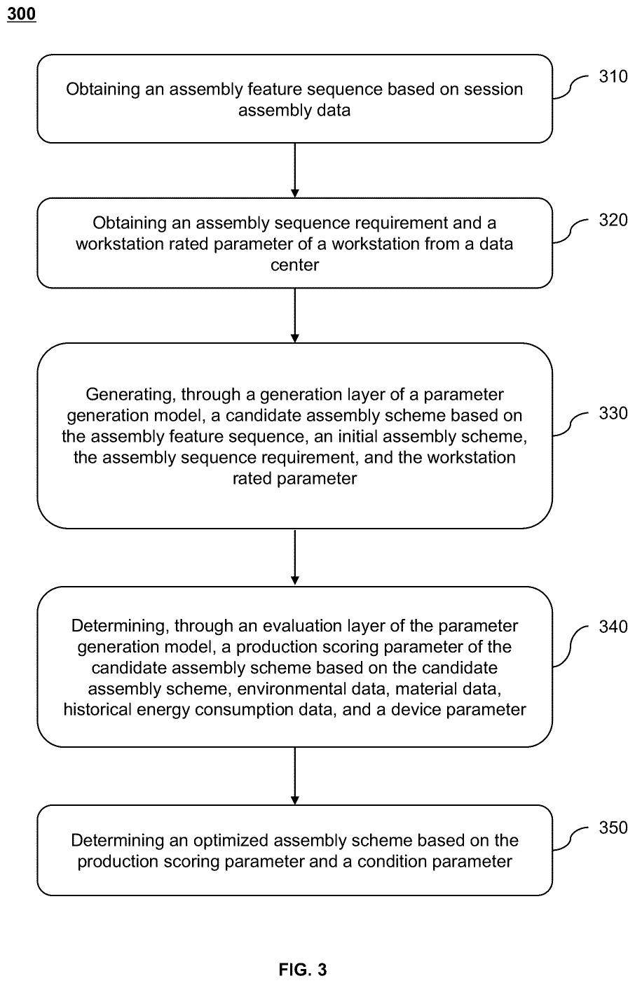

More embodiments regarding determining the optimized assembly scheme based on the session assembly data and the initial assembly scheme may be found elsewhere in the present disclosure (e.g., FIG. 3 and related descriptions thereof).

In 240, a target assembly scheme may be determined based on the optimized assembly scheme.

The target assembly scheme refers to an assembly scheme obtained by selecting on the basis of the optimized assembly scheme.

In some embodiments, the IIoT management platform may determine the target assembly scheme based on the optimized assembly scheme in various ways. For example, the IIoT management platform may select, based on the plurality of optimized assembly schemes, an optimized assembly scheme of which an adjusted total assembly time is less than an adjustment threshold and a count of adjusted assembly sessions is minimum as the target assembly scheme. The adjusted total assembly time refers to a sum of each assembly time in the assembly time sequence of the optimized assembly scheme.

The adjustment threshold refers to a preset minimum value of the adjusted total assembly time. The adjustment threshold may be preset by staff based on experience. In some embodiments, the adjustment threshold may be less than a time threshold. The time threshold refers to a preset maximum value of the total assembly time. The time threshold may be preset by staff based on experience.

In some embodiments, selecting the optimized assembly scheme with the minimum count of adjusted assembly sessions can reduce disruption to the production line while reducing the complexity of the adjustment process.

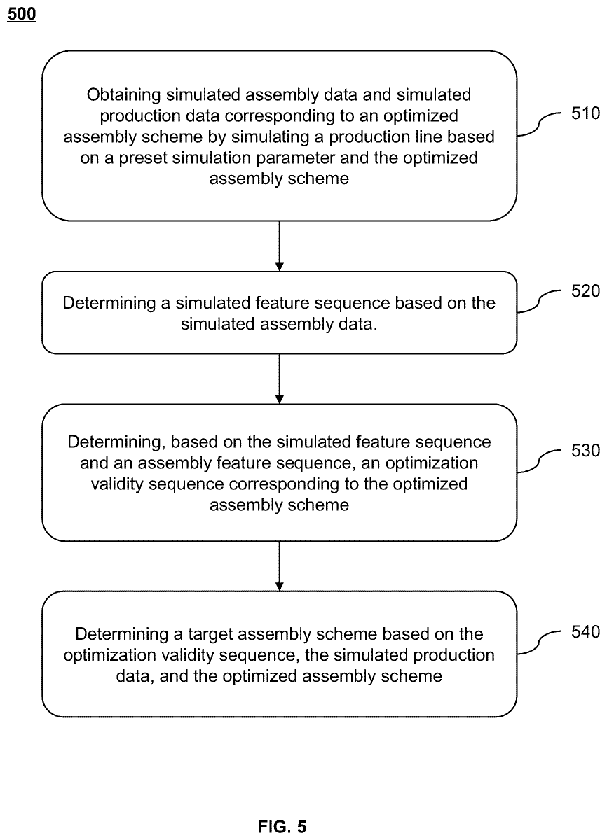

More embodiments regarding determining the target assembly scheme based on the optimized assembly scheme may be found elsewhere in the present disclosure (e.g., FIG. 5 and related descriptions thereof).

In 250, an assembly regulation instruction may be generated based on the target assembly scheme.

The assembly regulation instruction refers to an instruction for regulating a device involved in the assembly process.

In some embodiments, the IIoT management platform may generate the assembly regulation instruction based on the target assembly scheme in various ways. For example, the IIoT management platform may generate a current assembly regulation instruction based on the assembly assitance parameter in the target assembly scheme by modifying an assembly regulation instruction used last time, such as increasing the conveyor belt speed, or the like.

In 260, the target assembly scheme may be determined as a current assembly scheme and stored in a data center.

The current assembly scheme refers to an assembly scheme that is subsequently available for a current production line.

In 270, in response to determining that an adjustment time is reached, the assembly regulation instruction may be sent to the IIoT perceptual control platform to regulate a device operation parameter of a production device and a conveyor belt parameter of a conveyor belt.

The adjustment time refers to a preset time for adjusting an assembly session. In some embodiments, when the adjustment process needs to wait until the assembly of the components of a current batch is completed, the adjustment time is related to an assembly time of the components of the current batch. The adjustment time may be preset by staff based on experience.

The device operation parameter refers to a parameter related to an operation process of the production device. For example, the device operation parameter may include a robotic arm movement speed, a torque setting, an assembly speed, an assembly method, an assembly accuracy, or the like.

The conveyor belt parameter refers to a parameter related to an operation of the conveyor belt. For example, the conveyor belt parameter may include a conveyor belt speed, or the like.

In some embodiments, the IIoT management platform may regulate the device operation parameter of the production device and the conveyor belt parameter of the conveyor belt based on the assembly regulation instruction in various ways. For example, when the assembly regulation instruction includes increasing the assembly speed of the production device and decreasing the conveyor belt speed, the IIoT management platform may regulate to make a corresponding increase in the assembly speed of the production device and a corresponding decrease in the conveyor belt speed of the conveyor belt through the IIoT perceptual control platform.

In 280, reference assembly data of the production line may be obtained after the assembly regulation instruction is implemented based on the IIoT perceptual control platform.

The reference assembly data refers to assembly data after the production line implements the assembly regulation instruction.

In some embodiments, the IIoT management platform may obtain the reference assembly data through the data collection device.

In some embodiments, in response to determining that the reference assembly data meets a correction condition, the IIoT management platform may perform the following operations 291-294.

The correction condition may include that quality sampling data from the reference assembly data is not qualified, or the like. The correction condition may be preset by staff based on experience.

In 291, a correction optimization session of the current assembly scheme may be determined.

The correction optimization session refers to a session that needs to be corrected and optimized in the assembly scheme.

In some embodiments, the IIoT management platform may determine the correction optimization session in various ways. For example, the IIoT management platform may select a session that has at least one of a low assembly efficiency or a low assembly quality as the correction optimization session after the current assembly scheme is applied.

In 292, a corrected assembly scheme may be generated by correcting the current assembly scheme based on the correction optimization session.

The corrected assembly scheme refers to an assembly scheme after being corrected.

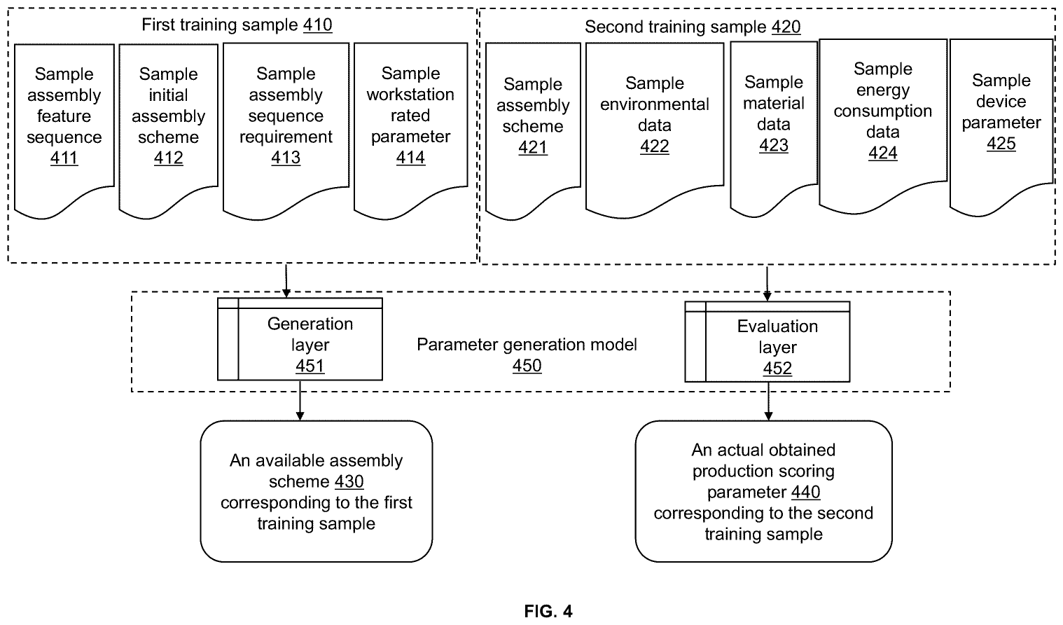

In some embodiments, the IIoT management platform may correct the current assembly scheme based on the correction optimization session in various ways. For example, for a correction optimization session with low assembly efficiency, the IIoT management platform may improve an assembly rate of the current assembly scheme. A magnitude of improving the assembly rate may be negatively correlated with a current assembly rate. As another example, for a correction optimization session with low assembly quality, the IIoT management platform may improve an assembly accuracy of the current assembly scheme. More descriptions regarding improving the assembly accuracy of the current assembly scheme may be found elsewhere in the present disclosure (e.g., FIG. 4 and related descriptions thereof).

In 293, the corrected assembly scheme may be stored in the data center, and a correction regulation instruction may be generated based on the corrected assembly scheme.

The correction regulation instruction refers to a regulation instruction generated based on the corrected assembly scheme.

A way of generating the correction regulation instruction based on the corrected assembly scheme may be similar to a way of generating the assembly regulation instruction based on the target assembly scheme, which is not repeated here.

In 294, the correction regulation instruction is sent to the IIoT perceptual control platform to correct the device operation parameter of the production device and the conveyor belt parameter of the conveyor belt.

A way of correcting the device operation parameter of the production device and the conveyor belt parameter of the conveyor belt based on the correction regulation instruction may be similar to a way of regulating the device operation parameter of the production device and the conveyor belt parameter of the conveyor belt based on the assembly regulation instruction, which is not repeated here.

In some embodiments of the present disclosure, the assembly scheme is dynamically adjusted through feedback after actual application of the assembly scheme, so as to improve the adaptability and flexibility of the system, detect and correct problems in actual production in time, and reduce assembly errors and faults. By Continuous optimization of the assembly scheme, the overall performance and efficiency of the production line can be effectively improved. In addition, with actual data verification, the feasibility and reliability of the optimized assembly scheme can be ensured, and the production risk can be reduced.

FIG. 3 is flowchart illustrating an exemplary process of determining an optimized assembly scheme according to some embodiments of the present disclosure.

In some embodiments, determining an optimized assembly scheme based on session assembly data and an initial assembly scheme may include: obtaining an assembly feature sequence based on the session assembly data; obtaining an assembly sequence requirement, and a workstation rated parameter of a workstation from a data center; generating, through a generation layer of a parameter generation model, a candidate assembly scheme based on the assembly feature sequence, the initial assembly scheme, the assembly sequence requirement, and the workstation rated parameter; the parameter generation model being a machine learning model; determining, through an evaluation layer of the parameter generation model, a production scoring parameter of the candidate assembly scheme based on the candidate assembly scheme, environmental data, material data, historical energy consumption data, and a device parameter; and determining the optimized assembly scheme based on the production scoring parameter and a condition parameter.

As shown in FIG. 3, a process 300 may include the following operations. In some embodiments, the process 300 may be performed by an IIoT management platform. More descriptions regarding the IIoT management platform may be found elsewhere in the present disclosure (e.g., FIG. 1 and the related descriptions thereof).

In 310, an assembly feature sequence may be obtained based on session assembly data.

The assembly feature sequence refers to a sequence consisting of a plurality of assembly features. The assembly features refer to data related to an assembly process. In some embodiments, the assembly feature sequence may include an actual assembly feature of a stage assembly component of each session. The actual assembly feature may include an assembly part object, an assembly quality, an assembly efficiency, front and rear stacking levels, an action time of a person or a machine, workstation utilization, or the like.

The front stacking level refers to accumulation of materials or semi-finished products output from an upstream workstation (i.e., a previous workstation) of a current workstation at an entrance to the current workstation. The rear stacking level refers to accumulation of materials or semi-finished products output from the current workstation at an entrance of a downstream workstation (i.e. a subsequent workstation). The workstation utilization refers to utilization of a production device contained in the workstation. More descriptions regarding the workstations may be found elsewhere in the present disclosure (e.g., FIG. 2 and the related descriptions thereof).

In some embodiments, the IIoT management platform may obtain the assembly feature sequence based on the session assembly data in various ways. For example, the IIoT management platform may obtain the actual assembly feature of each session by counting based on session assembly data in a preset time period.

Merely by way of an example, the IIoT management platform may count an average quality and an average efficiency of sampled samples in the preset time period, and an average action time of the person or the machine as the assembly quality, the assembly efficiency, and the action time of the person or the machine, respectively.

In 320, an assembly sequence requirement and a workstation rated parameter of a workstation may be obtained from a data center.

More descriptions regarding the data center may be found elsewhere in the present disclosure (e.g., FIG. 1 and the related descriptions thereof).

The assembly sequence requirement refers to an order requirement for assembling parts. The assembly sequence requirement may be any order.

The workstation rated parameter refers to a parameter configured to characterize a device characteristic and a device processing capacity of each workstation.

The device characteristic is a property that the production device has, such as a device type, a device specification, or the like.

The device processing capacity refer to ability, scope, and efficiency of the production device to process and complete work, such as types of parts that the production device can process, an assembly speed that the production device can achieve, or the like.

In 330, a candidate assembly scheme may be generated through a generation layer of a parameter generation model based on the assembly feature sequence, an initial assembly scheme, the assembly sequence requirement, and the workstation rated parameter.

More descriptions regarding the initial assembly scheme may be found elsewhere in the present disclosure (e.g., FIG. 2 and the related descriptions thereof).

The parameter generation model refers to a model for generating the candidate assembly scheme and a production scoring parameter corresponding to the candidate assembly scheme. In some embodiments, the parameter generation model may be a machine learning model, such as a Recurrent Neural Network (RNN) model, a Deep Neural Network (DNN) model, or the like.

The generation layer refers to a modeling layer for generating the candidate assembly scheme. In some embodiments, the generation layer may be a machine learning model, such as an RNN model, or the like.

More descriptions regarding the generation layer may be found elsewhere in the present disclosure (e.g., FIG. 4 and related descriptions thereof).

The candidate assembly scheme refers to a scheme that is a candidate optimized assembly scheme.

The IIoT management platforms may generate the candidate assembly scheme through the generation layer of the parameter generation model. More descriptions may be found elsewhere in the present disclosure (e.g., FIG. 4 and related descriptions thereof).

In some embodiments, the IIoT management platform may determine a first optimization session through an optimization session determination model based on the assembly feature sequence, the workstation rated parameter, the device parameter, and historical session assembly data; and determine the candidate assembly scheme based on the first optimization session.

The device parameter refers to a parameter related to a device on the production line, such as a device name, a device model, and a device state (e.g., a maintenance record, a fault record, or the like.).

In some embodiments, the device parameter may be obtained by a data collection device, or uploaded by staff.

The historical session assembly data refers to assembly data of a session that needs to be optimized in a historical time period. The historical time period refers to a period of time in the past, such as the past half hour, or the like.

The optimization session determination model refers to a model configured to determine an optimization session. In some embodiments, the optimization session determination model may be a machine learning model, such as an RNN model, or the like.

In some embodiments, an input of the optimization session determination model may include the assembly feature sequence, the workstation rated parameter, the device parameter, and the historical session assembly data; and an output of the optimization session determination model may include the first optimization session.

In some embodiments, the optimization session determination model may be obtained by training in various ways. For example, the optimization session determination model may be obtained by training a plurality of third training samples with third labels, or the like. A set of third training samples may include a sample assembly feature sequence, a sample workstation rated parameter, a sample device parameter, and sample historical session assembly data of a historical first time period. The third labels corresponding to the set of third training samples may include a first optimization session actually used in a historical second time period.

In some embodiments, the IIoT management platform may select historical session assembly data, a historical workstation rated parameter, and a historical device parameter in the historical first time period of a historical assembly process; determine a historical assembly feature sequence based on the historical session assembly data; determine the historical session assembly data, the historical workstation rated parameter, the historical device parameter, and the historical assembly feature sequence as a set of third training samples; and determine a session with a low actual assembly efficiency, a low assembly quality, or a large fluctuation in the assembly efficiency or the assembly quality in the historical second time period of the assembly process carried out under a condition of the set of third training samples as the third labels corresponding to the set of third training samples. The historical first time period may precede the historical second time period.

In this content, the low assembly efficiency and the low assembly quality means that the assembly efficiency and the assembly quality are below an efficiency threshold and a quality threshold, respectively. The large fluctuation in the assembly efficiency or the assembly quality means that a fluctuation in the assembly efficiency or the assembly quality is greater than an efficiency fluctuation threshold or a quality fluctuation threshold, respectively. In some embodiments, the fluctuation in the assembly efficiency and the fluctuation in the assembly quality may be expressed as a difference between upper and lower limits of the assembly efficiency and a difference between upper and lower limits of the assembly quality, respectively. The efficiency threshold, the quality threshold, the efficiency fluctuation threshold, and the quality fluctuation threshold may all be preset by staff based on experience.

In some embodiments, the IIoT management platform may input the third training samples into an initial session optimization model, construct a third loss function based on an output of the initial session optimization model and the third labels, and iteratively update the initial session optimization model based on the third loss function. When a preset condition is met, the training is completed, and a trained optimization session determination model is obtained. The preset condition may be that the third loss function converges, a count of iterations reaches a threshold, or the like.

The first optimization session refers to a session where the assembly efficiency and the assembly quality of the assembly scheme are low or fluctuate greatly at a current or future time.

In some embodiments, the IIoT management platform may determine the candidate assembly scheme based on the first optimization session in various ways. For example, the IIoT management platform may generate a plurality of candidate assembly schemes by randomly adjusting the first optimization sessions based on the first optimization sessions in conjunction with various adjustment magnitudes using various adjustment means. The adjustment means may include, but are not limited to, increasing the assembly speed, increasing the assembly accuracy, or the like. Merely by way of an example, a change in the assembly accuracy may be realized by changing an assembly process during actual production. Changing the assembly process include using assembly tools with different precision, using more accurate speed and pressure control schemes, introducing more precise positioning systems, or the like.

In some embodiments of the present disclosure, by the machine learning model, the accuracy of the first optimization session can be ensured and the time loss of the arithmetic process can be reduced; by adjusting the first optimization session to obtain the candidate assembly scheme, the efficiency of obtaining the candidate assembly scheme can be improved, while making the candidate assembly scheme more targeted.

In 340, a production scoring parameter of the candidate assembly scheme may be determined through an evaluation layer of the parameter generation model based on the candidate assembly scheme, environmental data, material data, historical energy consumption data, and a device parameter.

The environmental data refers to data related to an environment where the assembly is located, such as an ambient temperature, an ambient humidity, or the like. In some embodiments, the environmental data may be obtained by the data collection device. More descriptions regarding the data collection device may be found elsewhere in the present disclosure (e.g., FIG. 1 and the related descriptions thereof).

The material data refers to data related to materials used in the assembly process, such as a name, a specification, and a material of units or components from which the parts are constructed.

The historical energy consumption data refers to data related to energy consumed during the assembly process, such as electrical energy consumption.

The evaluation layer refers to a modeling layer for generating the production scoring parameter of the candidate assembly scheme. In some embodiments, the evaluation layer may be a machine learning model, such as a DNN model, or the like.

More descriptions regarding the evaluation layer may be found elsewhere in the present disclosure (e.g., FIG. 4 and related descriptions thereof).

The production scoring parameter refers to data related to scoring the candidate assembly scheme. For example, the production scoring parameter may include a production rate, a scrap rate, a fault rate, or the like.

In 350, an optimized assembly scheme may be determined based on the production scoring parameter and a condition parameter.

The conditional parameter refers to a preset parameter related to determining the optimized assembly scheme. For example, the condition parameter may include a preset production rate, a preset scrap rate, a preset fault rate, or the like. The preset production rate, the preset scrap rate, and the preset fault rate may be preset by staff based on experience.

In some embodiments, the IIoT management platform may select, based on the production scoring parameter and the condition parameter, a candidate assembly scheme of which a production rate greater than the preset production rate, a scrap rate is less than the preset scrap rate, and a fault rate is less than the preset fault rate as the optimized assembly scheme.

In some embodiments of the present disclosure, the obtained assembly feature sequence conforms to the actual production process by the session assembly data; by determining the candidate assembly scheme and the corresponding production scoring parameter based on the machine learning model, the determination of the candidate assembly scheme is more accurate, and time consumption of the determination process is saved; and the accuracy of the optimized assembly scheme can be improved based on the production scoring parameter and the condition parameter.

FIG. 4 is a schematic diagram illustrating an exemplary parameter generation model according to some embodiments of the present disclosure.

In some embodiments, the parameter generation model 450 may be obtained by training a training sample dataset. A training process of the parameter generation model 450 may include an initial training phase and an intensive training phase.

The training sample dataset refers to a dataset configured to train the parameter generation model. As shown in FIG. 4, training samples in the training sample dataset may include a first training sample 410, a second training sample 420, a first label corresponding to the first training sample, and a second training sample corresponding to the second label.

The first training sample 410 is applied to train a generation layer 451. The first training sample 410 includes a sample assembly feature sequence 411, a sample initial assembly scheme 412, a sample assembly sequence requirement 413, and a sample workstation rated parameter 414. The first label includes an available assembly scheme 430 corresponding to the first training sample.

The second training sample 420 is applied to train an evaluation layer 452. The second training sample 420 includes a sample assembly scheme 421, sample environmental data 422, sample material data 423, sample energy consumption data 424, and a sample device parameter 425. The second label includes an actual obtained production scoring parameter 440 corresponding to the second training sample. More descriptions regarding the parameter generation model, the generation layer, and the evaluation layer may be found elsewhere in the present disclosure (e.g., FIG. 3 and the related descriptions thereof).

In some embodiments, the IIoT management platform may obtain the first training sample and the first label corresponding to the first training sample in various ways. For example, the IIoT management platform may analyze historical assembly schemes, select a historical subsequent assembly scheme of which an adjusted production rate is higher than a production rate of a historical initial assembly scheme, determine the historical subsequent assembly scheme as the first label, determine the historical initial assembly scheme corresponding to the historical subsequent assembly scheme as the sample initial assembly scheme, and determine a historical assembly feature sequence, a historical assembly sequence requirement, and a historical workstation rated parameter corresponding to the historical initial assembly scheme as the sample assembly feature sequence, the sample assembly sequence requirement, and the sample workstation rated parameter, respectively.

The IIoT management platform may obtain a plurality of first training samples and first labels corresponding to the first training samples based on a plurality of historical assembly schemes according to the above method.

As another example, for an initial assembly scheme, the staff may generate a plurality of experimental assembly schemes based on experience, use the initial assembly scheme and the experimental assembly schemes in a production line, select an experimental assembly scheme of which a production rate is higher than that of the initial assembly scheme as a candidate assembly scheme corresponding to the initial assembly scheme, i.e., the first label, and use an assembly feature sequence, an assembly sequence requirement, and a workstation rated parameter corresponding to the initial assembly scheme as the sample assembly feature sequence, the sample assembly sequence requirement, and the sample workstation rated parameter, respectively; and repeat a number of times to obtain the plurality of first training samples and the first labels corresponding to the first training samples.

In some embodiments, second training samples and second labels may be obtained based on simulation data.

The simulation data refers to data obtained by simulating an assembly process.

In some embodiments, the IIoT management platform may obtain the second training samples and the second labels corresponding to the second training samples by simulating based on a simulation tool. More descriptions regarding the simulation tool and the simulation may be found elsewhere in the present disclosure (e.g., FIG. 5 and related descriptions thereof).

In some embodiments of the present disclosure, obtaining the second training samples and the second labels by simulation can reduce the time consumption for obtaining training data while ensuring the accuracy of the training data.

The initial training phase refers to a pre-training phase before the parameter generation model is accessed to a specific plant. In the initial training phase, the training sample dataset may be obtained based on a general dataset on a cloud platform.

The intensive training phase refers to a phase in which the parameter generation model performs customized training based on each plant. In the intensive training phase, the training sample dataset may be obtained based on historical data actually collected in a plant, and a proportion of samples corresponding to a fault type may not be less than a preset threshold.

The fault type refers to a type of fault that occurs, such as a conveyor belt fault, a robotic arm fault, or the like.

The preset threshold may be preset by staff based on experience.

In some embodiments, the preset threshold may be positively correlated with a loss cost corresponding to the fault type.

The loss cost refers to a cost of a loss due to the fault.

In some embodiments, the IIoT management platform may determine the loss cost corresponding to the fault type by querying a preset table. The preset table refers to a table that includes a correspondence between the fault type and the loss cost. For example, the IIoT management platform may count one historical fault type and an actual loss cost corresponding to the historical fault type in historical data, average the actual loss costs corresponding to a plurality of the historical fault types, and determine an average value of the actual loss costs as the loss cost corresponding to the historical fault type in the table. The IIoT management platform may obtain the plurality of fault types and the loss costs corresponding to the fault types by the method described above.

In some embodiments, the IIoT management platform may obtain the generation layer and the evaluation layer through separate training, or may obtain the generation layer and the evaluation layer through joint training.

A process of separate training of the generation layer is as follows.

In some embodiments, the IIoT management platform may input the first training sample into an initial generation layer, construct a first loss function based on an output of the initial generation layer and the first label, iteratively update the initial generation layer based on the first loss function. When a first preset condition is met, the training is completed and a trained generation layer is obtained. The first preset condition may be that the first loss function converges, a count of iterations reaches a threshold, or the like.

A process of separate training of the evaluation layer may be similar to the process of separate training of the generation layer, which is not repeated here.

A process of jointly training of the generation layer and the evaluation layer is as follows.

In some embodiments, the IIoT management platform may input the first training sample into the initial generation layer to obtain the output of the initial generation layer; input the output of the initial generation layer and other parameters of the second training sample, i.e., the sample environmental data, the sample material data, the sample energy consumption data, and the sample device parameter, into an initial evaluation layer to obtain an output of the initial evaluation layer; construct a second loss function based on the output of the initial evaluation layer and the second label; iteratively update the initial evaluation layer and the initial generation layer based on the second loss function; and when a second preset condition is met, complete the training and obtain the trained generation layer and a trained evaluation layer. The second preset condition may be that the second loss function converges, a count of iterations reaches a threshold, or the like.

In some embodiments, an input of the generation layer of the parameter generation model may further include a first optimization session.

In some embodiments, when the input of the generation layer of the parameter generation model includes the first optimization session, the first training samples may further include a sample first optimization session.

In some embodiments, the IIoT management platform may obtain the first training sample that includes the sample first optimization session in various ways. For example, for the initial assembly scheme, the staff may generate the first optimization sessions of the initial assembly scheme based on experience, obtain a plurality of experimental assembly schemes by adjusting the first optimization session, use the initial assembly scheme and the experimental assembly schemes on the production line, select an experimental assembly scheme of which a production rate higher than that of the initial assembly scheme as the candidate assembly scheme corresponding to the initial assembly scheme, i.e., the first label, and use the first optimization session, the assembly feature sequence, the assembly sequence requirement, and the workstation rated parameter corresponding to the initial assembly scheme, as the sample first optimization session, the sample assembly feature sequence, the sample assembly sequence requirement, and the sample workstation rated parameter, respectively; and repeat a number of times to obtain the plurality of first training samples and the first labels corresponding to the first training samples.

More descriptions regarding the first optimization session may be found elsewhere in the present disclosure (e.g., FIG. 3 and the related descriptions thereof).

In some embodiments of the present disclosure, by determining the first optimization session as the input of the generation layer, the model can focus on specific problem of the session, making the generated candidate assembly scheme more targeted instead of a randomly generated generalized scheme, and avoiding generation of a large number of irrelevant candidate schemes, thereby saving computational resources and time. Meanwhile, high effectiveness and feasibility of the generated candidate assembly scheme are ensured, thereby significantly improving the overall performance of the production line.

In some embodiments of the present disclosure, a large amount of general datasets are used for pre-training in the initial training phase, such that the parameter generation model has a good generalization ability in a wide range of situations, which further enables the parameter generation model to be more quickly adapted to the specific plant when exposed to the data of the specific plant. In the intensive training phase, the customizaed training is performed based on the actual data collected from each plant, which further improves the adaptability and accuracy of the model in a specific plant environment. The phased training approach ensures that the model has both broad applicability and targeted optimization capacity. In addition, in the intensive training phase, it is ensured that the proportion of samples corresponding to each fault type is not less than the preset threshold, which helps the model to better learn various fault modes, and improves the accuracy of the fault detection and processing. The preset threshold is set to be positively correlated with the loss costs corresponding to the fault types, which allows the model to pay more attention to the fault types that cause greater losses once occur, thereby prioritizing the optimization of the critical sessions.

FIG. 5 is a flowchart illustrating an exemplary process of determining a target assembly scheme according to some embodiments of the present disclosure.

In some embodiments, determining a target assembly scheme based on an optimized assembly scheme may include: obtaining simulated assembly data and simulated production data corresponding to the optimized assembly scheme by simulating a production line based on a preset simulation parameter and the optimized assembly scheme, the preset simulation parameter including a simulated intensity sequence; determining a simulated feature sequence based on the simulated assembly data; determining, based on the simulated feature sequence and the assembly feature sequence, an optimization validity sequence corresponding to the optimized assembly scheme; and determining the target assembly scheme based on the optimization validity sequence, the simulated production data, and the optimized assembly scheme.

As shown in FIG. 5, a process 500 may include the following operations. In some embodiments, the process 500 may be performed by an IIoT management platform. More descriptions regarding the IIoT management platform may be found elsewhere in the present disclosure (e.g., FIG. 1 and the related descriptions thereof).

In 510, simulated assembly data and simulated production data corresponding to an optimized assembly scheme may be obtained by simulating a production line based on a preset simulation parameter and the optimized assembly scheme, the preset simulation parameter including a simulated intensity sequence.

More descriptions regarding the optimized assembly scheme and the production line may be found elsewhere in the present disclosure (e.g., FIG. 2 and the related descriptions thereof).

The preset simulation parameter refers to a parameter that is preset for simulation of the production line.

The simulation intensity sequence refers to a sequence combination of simulation efficiency and simulation strength.

In some embodiments, the simulation intensity sequence may include a modeling accuracy, a selection of simulation algorithms, an allocation of computational resources of sessions, or the like. The allocation of computational resources may include GPU or CPU, and content allocation, or the like.

In some embodiments, the IIoT management platform may determine a simulation parameter of each assembly session based on an assembly level and an assembly type.

The assembly level is configured to characterize an assembly order of the session in an assembly process. The lower assembly level, and the more advanced the assembly order of the session in the assembly process. The assembly type refers to a type of part for assembly in the session. The assembly level and the assembly type may be expressed as a numerical value, respectively. For example, in a first session, a and b are assembled together to form c; in a second session, d and e are assembled together to form f; and in a third session, c, f, and h are assembled together to form g, wherein the first session and the second session are the basis of the third session. Therefore, the assembly level of the first session is 1, and the assembly type of the first session is 2; the assembly level of the second session is 1, and the assembly type of the second session is 2; and the assembly level of the third session is 2, and the assembly type of the third session is 3.

In some embodiments, the higher the assembly level of the session and the more the assembly type, the higher the simulation intensity of the session. That is, the higher the modeling accuracy of the session, the stronger the simulation algorithm selected and the more computational resources to be allocated.

In some embodiments, the preset simulation parameter may be positively correlated with a session complexity parameter. The session complexity parameter may be determined based on a workstation rated parameter, a component interconnection, an assembly component object, and a process difficulty factor.

The session complexity parameter may characterize a complexity, a difficulty, or the like, of a session assembly process. For example, the greater the count of the assembly types and the greater the count of assembly steps involved in the session assembly process, the greater the assembly time at a same assembly speed, the greater the assembly error rate, and the greater the session complexity parameter.

In some embodiments, the session complexity parameter may be expressed as a numerical value. The greater the value of the session complexity parameter, the greater the complexity of the session assembly process.

More descriptions regarding the workstation rated parameter may be found elsewhere in the present disclosure (e.g., FIG. 3 and the related descriptions thereof).

The component interconnection refers to a connection relationship between components of a workstation assembly process.

In some embodiments, the component interconnection may include a connection type and a connection sequence.

The connection type may be at least one of bolting, welding, bonding, or the like.

The connection sequence prioritizes the assembly of certain parts as a basis and prerequisite for subsequent assembly steps.

The assembly component object refers to a component involved in the assembly process.

The process difficulty factor refers to an indicator for evaluating the degree of process difficulty.

In some embodiments, the process difficulty factor may include a process accuracy and an operation complexity.

The process accuracy refers to an accuracy required for the assembly of a component. For example, some components are assembled with a required accuracy of ±0.01 mm, with a high degree of process accuracy.

The operation complexity refers to a complexity of the assembly process. For example, if certain assembly steps require multi-axis synchronous motion, the operation complexity is high.

In some embodiments, the higher the process accuracy and the greater the operation complexity, the greater the process difficulty factor.

In some embodiments, the process difficulty factor may be obtained by actually measuring operation data of a target process.

In some embodiments, the session complexity parameter may be determined by vector matching. For example, the IIoT management platform may construct a process feature vector based on the workstation rated parameter, the component interconnection, the assembly component object, and the process difficulty factor; and determine the session complexity parameter by retrieving a vector database based on the process feature vector.

The process feature vector refers to a vector configured to characterize a process feature. For example, the process feature vector may be represented as (x₀, y₀, z₀, t₀). x₀, y₀, z₀, and to may represent a workstation rated parameter, a component interconnection, an assembly component object, and a process difficulty factor corresponding to a workstation numbered 0.

The vector database refers to a database that supports similarity search on high-dimensional vectors, such as Milvus, Faiss, or the like.

In some embodiments, the vector database may include a plurality of reference feature vectors and reference complexity parameters corresponding to the reference feature vectors.

In some embodiments, the IIoT management platform may construct the vector database based on historical data. For example, the IIoT management platform may construct a reference feature vector based on the workstation rated parameter, the component interconnection, the assembly component object, and the process difficulty factor during a historical production assembly process. A way of constructing the reference feature vector may be similar to the way of constructing the process feature vector described above, which is not repeated here. The more types of units or components and the more steps are involved in the historical production assembly process, the longer the assembly time under the same assembly speed, the higher the assembly error rate, and the greater the session complexity parameter. The assembly error rate may include a probability of misalignment, unassembled, unsecure, and other error conditions. Meanwhile, the reference complexity parameter corresponding to the reference feature vector may be obtained by calling the historical production data stored by the system. Based on the method described above, the IIoT management platform may obtain a plurality of reference feature vectors and reference complexity parameters corresponding to the reference feature vectors, so as to construct the vector database.

In some embodiments, the IIoT management platform may determine the session complexity parameter based on similarities between the process feature vector and the plurality of reference feature vectors in the vector database. For example, the IIoT management platform may determine a reference feature vector of which a similarity between the process feature vector and the process feature vector meets a preset condition as a target vector, and determine a reference complexity parameter corresponding to the target vector as the session complexity parameter. The preset condition may be set as appropriate. For example, the similarity is maximum, or the similarity is greater than a similarity threshold, or the like. The similarity threshold may be set based on experience.

In some embodiments of the present disclosure, the session complexity parameter is determined based on the workstation rated parameter, the component interconnection, the assembly component object, and the process difficulty factor, such that the one-sidedness in evaluating the process complexity in a single dimension can be avoided, thereby making the determined session complexity parameter more objective and accurate.

The simulated assembly data refers to session assembly data obtained during simulation.

The simulated production data refers to production data obtained by simulating the production line based on the optimized assembly scheme. In some embodiments, the simulated production data may include a scrap rate and a fault rate.

In some embodiments, the IIoT management platform 130 may simulate the production line through a simulation tool based on at least one preset simulation parameter and at least one optimized assembly scheme. The simulation tool may include a simulation software based on virtual reality (VR) or augmented reality (AR) technology, such as Unity+VRTK, ARKit, or the like.

In some embodiments, the simulation tool may simulate the entire production line, or may simulate one or more production sessions of the production line separately. In some embodiments, the session simulation requires an output of an upstream session as input data. The simulation tool may determine a simulation sequence based on the assembly level. For example, the simulation tool prioritizes simulation of a session with a low assembly level, and then performs simulation of a session with a high assembly level based on an output result of the session with the low assembly level.

In some embodiments, the IIoT management platform may obtain at least one set of simulated assembly data corresponding to the at least one optimized assembly scheme.

In 520, a simulated feature sequence may be determined based on the simulated assembly data.

The simulated feature sequence refers to a feature information sequence of the production line in a simulation process.

In some embodiments, the IIoT management platform may determine at least one set of simulated feature sequence based on the simulated assembly data. More descriptions regarding the simulated feature sequence may be found elsewhere in the present disclosure (e.g., descriptions related to the assembly feature sequence in FIG. 3).

In 530, an optimization validity sequence corresponding to the optimized assembly scheme may be determined based on the simulated feature sequence and an assembly feature sequence.

More descriptions regarding the assembly feature sequence may be found elsewhere in the present disclosure (e.g., FIG. 3 and the related descriptions thereof). More descriptions regarding the optimized assembly scheme may be found elsewhere in the present disclosure (e.g., FIG. 2 and the related descriptions thereof).

The optimization validity sequence is configured to evaluate an effectiveness degree of a correction optimization session. One optimized assembly scheme may correspond to at least one optimization validity sequence.

In some embodiments, the IIoT management platform may determine the optimization validity sequence by comparing assembly qualities, assembly efficiencies, front stacking degrees, rear stacking degrees, and workstation utilization of the simulated feature sequence and the assembly feature sequence. For example, the optimization validity sequence of each assembly session may be determined by the following equation (1):

$$A = B ( {B}_{1} - {B}_{2} ) + C ( {C}_{1} - {C}_{2} ) + D ( {D}_{1} - {D}_{2} ) + E ( {E}_{1} - {E}_{2} ) + F ( {F}_{1} - {F}_{2} ) \qquad ( 1 )$$

where A denotes an optimization validity; B denotes an assembly quality coefficient; B₁ denotes a simulated assembly quality; B₂ denotes an actual assembly quality; C denotes an assembly efficiency coefficient; C₁ denotes a simulated assembly efficiency; C₂ denotes an actual assembly efficiency; D denotes a front stacking degree coefficient; D₁ denotes an actual front stacking degree; D₂ denotes a simulated front stacking degree; E denotes a rear stacking degree coefficient; E₁ denotes an actual rear stacking degree; E₂ denotes a simulated rear stacking degree; F denotes a workstation utilization coefficient; F₁ denotes simulated workstation utilization, and F₂ denotes actual workstation utilization. The optimization validity sequence of the each assembly session may be further determined based on the optimization validity of each assembly session.

The coefficients B, C, D, E, and F may be preset based on experience; B₁, C₁, D₂, E₁, and F₁ may be obtained based on the simulated feature sequence; and B₂, C₂, D₁, E₂, and F₂ may be obtained based on an actual assembly feature sequence.

In 540, a target assembly scheme may be determined based on the optimization validity sequence, the simulated production data, and the optimized assembly scheme.

More descriptions regarding the target assembly scheme may be found elsewhere in the present disclosure (e.g., FIG. 2 and the related descriptions thereof).

In some embodiments, the IIoT management platform may select, based on a plurality of optimized assembly schemes, a set of optimized assembly scheme of which a total optimization validity is highest, a scrap rate is less than a scrap threshold, and a production fault rate is less than a fault threshold as the target assembly scheme.

The total optimization validity is configured to evaluate the effectiveness degree of the optimized assembly scheme.

In some embodiments, the total optimization validity may be determined in various ways. For example, the total optimization validity may be a sum or a weighted sum of the optimization validities corresponding to all the optimized assembly sessions. A weight corresponding to each correction optimization session may be related to an importance of the correction optimization session. The more important the correction optimization session, the greater the weight.

In some embodiments, the importance of the correction optimization session may be determined in various ways. For example, the importance of the correction optimiziation session may be determined by those skilled in the art based on experience. As another example, the IIoT management platform may determine the importance of the correction optimization session by determining the degree of influence of each correction optimization session on the assembly efficiency and the assembly quality of the overall assembly process through a statistical method (e.g., regression analysis, correlation analysis, or the like). For example, an importance of a session M may be considered to be high if a decrease in the assembly accuracy or a fault of the session M results in an increase in the scrap rate or a decrease in the quality of the finished product. The greater the magnitude of the increase in the scrap rate and/or the decrease in the quality, the greater the importance of the session.

In some embodiments, the IIoT management platform may determine a second optimization session based on the optimization validity sequence and a validity threshold; and determine an updated target assembly scheme by updating the target assembly scheme based on the second optimization session.

The validity threshold is configured to evaluate whether the optimized assembly scheme reaches an expected validity degree.

In some embodiments, the validity threshold may be positively correlated with the session complexity parameter.

The second optimization session refers to a session that can be optimized again in the simulation process, such as a session with a relatively high importance and/or an underperforming session.

In some embodiments, the IIoT management platform may determine an assembly session in the optimized assembly scheme of which an optimization validity is lower than the validity threshold and/or an assembly rate is lower than a rate threshold as the second optimization session. The rate threshold may be obtained by manual presetting.

In some embodiments, the IIoT management platform may obtain the second optimization session based on the simulated feature sequence through an optimization session determination model. More descriptions may be found in the descriptions for obtaining the first optimization session based on the optimization session determination model in FIG. 3.

In some embodiments, the IIoT management platform may directly update the optimized assembly scheme based on the second optimization session. For example, the IIoT management platform may directly randomly adjust a parameter of a workstation corresponding to the second optimization session. In some embodiments, the IIoT management platform may input the second optimization session into a generation layer of a parameter generation model to obtain a plurality of updated candidate assembly schemes. More descriptions may be found elsewhere in the present disclosure (e.g., FIG. 3 and the related descriptions of FIG. 3).

In some embodiments, the IIoT management platform may determine optimized assembly schemes with the second optimization sessions as the updated candidate assembly scheme; evaluate whether the plurality of updated candidate assembly schemes meet a preset condition based on an evaluation layer of the parameter generation model, and determine an updated candidate assembly scheme that meets the preset condition as the updated optimized assembly scheme. The preset condition may be that at least one of the production rate, the scrap rate, and the fault rate is better than a corresponding parameter in the target assembly scheme.

In some embodiments, the simulation tool may determine the updated target assembly scheme based on the updated optimized assembly scheme by simulating the production line through the method of the operations 510-540 in FIG. 5. The second optimization session may be determined again by updating the target assembly scheme, and determine the updated target assembly scheme by directly updating the optimized assembly scheme based on the second optimization session, or by performing multiple iterations of updating based on the method of the operations 510-540 in FIG. 5 until a preset target is reached. The preset target may be that a count of updates reaches a preset update number, or a difference between a total optimization validity determined by the last simulation and a total optimization validity determined by a previous simulation is less than an update threshold. The update threshold may be preset based on experience.

In some embodiments of the present disclosure, the updated target assembly scheme is determined by optimizing and updating the optimized assembly scheme several times based on at least one of key sessions or unreasonable sessions in the optimized assembly scheme, such that the optimized assembly scheme can be optimized in a more targeted manner, and flaws in the optimized assembly scheme can be gradually eliminated, thereby improving the updated target assembly scheme.

In some embodiments of the present disclosure, the target assembly scheme is determined by simulating the optimized assembly scheme, such that the feasibility of a preset scheme can be verified, potential problems in the scheme can be discovered and solves in advance, and additional costs and losses due to production errors can be reduced. In addition, the design of the production line can be optimized, thereby further optimizing resource allocation, and improving the assembly efficiency.

It should be noted that the foregoing descriptions of the process 200, the process 300, and the process 500 are intended to be exemplary and illustrative only, and do not limit the scope of application of the present disclosure. For those skilled in the art, the process 200, the process 300, and the process 500 may be subjected to various corrections and changes under the knowledge of the present disclosure. However, these corrections and changes are still within the scope of the present disclosure.

What is claimed is:

1. An assembly optimization method based on Industrial Internet of Things (IIoT), implemented by an IIoT management platform based on the IIoT, wherein the IIoT includes an IIoT user platform, an IIoT service platform, the IIoT management platform, an IIoT sensor network platform, and an IIoT perceptual control platform;
the IIoT management platform is in communication with the IIoT sensor network platform and the IIoT service platform; the IIoT perceptual control platform includes a production device of a production line and a data collection device disposed on the production line, the IIoT perceptual control platform realizes data interaction with the IIoT management platform through the IIoT sensor network platform;
the assembly optimization method comprises:
obtaining session assembly data of the production line through the IIoT perceptual control platform, and uploading the session assembly data to the IIoT management platform through the IIoT sensor network platform;
obtaining an initial assembly scheme from a scheme database, the scheme database being stored in a data center of the IIoT management platform;
determining an optimized assembly scheme based on the session assembly data and the initial assembly scheme;
determining a target assembly scheme based on the optimized assembly scheme;
generating an assembly regulation instruction based on the target assembly scheme;
determining the target assembly scheme as a current assembly scheme and storing the current assembly scheme in the data center;
in response to determining that adjustment time is reached, sending the assembly regulation instruction to the IIoT perceptual control platform to regulate a device operation parameter of the production device and a conveyor belt parameter of a conveyor belt;
obtaining, based on the IoT perceptual control platform, reference assembly data of the production line after the assembly regulation instruction is implemented;
in responding to determining that the reference assembly data meets a correction condition:
determining a correction optimization session of the current assembly scheme;
generating a corrected assembly scheme by correcting the current assembly scheme based on the correction optimization session;
storing the corrected assembly scheme in the data center, and generating a correction regulation instruction based on the corrected assembly scheme; and
sending the correction regulation instruction to the IIoT perceptual control platform to correct the device operation parameter of the production device and the conveyor belt parameter of the conveyor belt.

2. The assembly optimization method of claim 1, wherein the determining an optimized assembly scheme based on the session assembly data and the initial assembly scheme includes:
obtaining an assembly feature sequence based on the session assembly data;
obtaining an assembly sequence requirement and a workstation rated parameter of a workstation from the data center;
generating, through a generation layer of a parameter generation model, a candidate assembly scheme based on the assembly feature sequence, the initial assembly scheme, the assembly sequence requirement, and the workstation rated parameter; the parameter generation model being a machine learning model;
determining, through an evaluation layer of the parameter generation model, a production scoring parameter of the candidate assembly scheme based on the candidate assembly scheme, environmental data, material data, historical energy consumption data, and a device parameter; and
determining the optimized assembly scheme based on the production scoring parameter and a condition parameter.

3. The assembly optimization method of claim 2, wherein the parameter generate model is obtained by training based on a training sample dataset, a training process of the parameter generation model includes an initial training phase and an intensive training phase; wherein training samples of the training sample dataset include first training samples, second training samples, first labels corresponding to the first training samples, and second labels corresponding to the second training samples;
the first training samples are applied to train the generation layer, the first training samples include a sample assembly feature sequence, a sample initial assembly scheme, a sample assembly sequence requirement, and a sample workstation rated parameter, and the first labels include available assembly schemes corresponding to the first training samples;
the second training samples are applied to train the evaluation layer, the second training samples include a sample assembly scheme, sample environmental data, sample material data, sample energy consumption data, and a sample device parameter, and the second labels include actual acquired production scoring parameters corresponding to the second training samples;
in the initial training phase, the training sample datasets is obtained based on a general dataset on a cloud platform;
in the intensive training phase, the training sample dataset is obtained based on historical data actually collected in a plant, and a proportion of samples corresponding to a fault type is not less than a preset threshold; and
the preset threshold is positively correlated with a loss cost corresponding to the fault type.

4. The assembly optimization method of claim 3, wherein the second training samples and the second labels are obtained based on simulation data.

5. The assembly optimization method of claim 2, further comprising:
determining a first optimization session through an optimization session determination model based on the assembly feature sequence, the workstation rated parameter, the device parameter, and historical session assembly data; the optimization session determination model being a machine learning model; and
determining the candidate assembly scheme based on the first optimization session.

6. The assembly optimization method of claim 2, wherein an input of the generation layer of the parameter generation model further includes a first optimization session.

7. The assembly optimization method of claim 1, wherein the determining a target assembly scheme based on the optimized assembly scheme includes:
obtaining simulated assembly data and simulated production data corresponding to the optimized assembly scheme by simulating the production line based on a preset simulation parameter and the optimized assembly scheme, the preset simulation parameter including a simulated intensity sequence;
determining a simulated feature sequence based on the simulated assembly data;
determining, based on the simulated features sequence and the assembly feature sequence, an optimization validity sequence corresponding to the optimized assembly scheme; and
determining the target assembly scheme based on the optimization validity sequence, the simulated production data, and the optimized assembly scheme.

8. The assembly optimization method of claim 7, wherein the preset simulation parameter is positively correlated with a session complexity parameter;
the session complexity parameter is determined based on a workstation rated parameter, a component interconnection, an assembly component object, and a process difficulty factor.

9. The assembly optimization method of claim 7, further comprising:
determining a second optimization session based on the optimization validity sequence and a validity threshold; and
determining an updated target assembly scheme by updating the target assembly scheme based on the second optimization session.

10. An assembly optimization system based on Industrial Internet of Things (IIoT), comprising an IIoT user platform, an IIoT service platform, an IIoT management platform, an IIoT sensor network platform, and an IIoT perceptual control platform; wherein
the IIoT management platform is in communication with the IIoT sensor network platform and the IIoT service platform; the IIoT perceptual control platform includes a production device of a production line and a data collection device disposed on the production line, the IIoT perceptual control platform realizes data interaction with the IIoT management platform through the IIoT sensor network platform;
the IIoT management platform is configured to:
obtain session assembly data of the production line through the IIoT perceptual control platform, and upload the session assembly data to the IIoT management platform through the IIoT sensor network platform;
obtain an initial assembly scheme from a scheme database, the scheme database being stored in a data center of the IIoT management platform;
determine an optimized assembly scheme based on the session assembly data and the initial assembly scheme;
determine a target assembly scheme based on the optimized assembly scheme;
generate an assembly regulation instruction based on the target assembly scheme;
determine the target assembly scheme as a current assembly scheme and store the current assembly scheme in the data center;
in response to determining that adjustment time is reached, send the assembly regulation instruction to the IIoT perceptual control platform to regulate a device operation parameter of the production device and a conveyor belt parameter of a conveyor belt;
obtain, based on the IoT perceptual control platform, reference assembly data of the production line after the assembly regulation instruction is implemented;
in responding to determining that the reference assembly data meets a correction condition:
determine a correction optimization session of the current assembly scheme;
generate a corrected assembly scheme by correcting the current assembly scheme based on the correction optimization session;
store the corrected assembly scheme in the data center, and generate a correction regulation instruction based on the corrected assembly scheme; and
send the correction regulation instruction to the IIoT perceptual control platform to correct the device operation parameter of the production device and the conveyor belt parameter of the conveyor belt.

11. The assembly optimization system of claim 10, wherein the IIoT management platform is further configured to:
obtain an assembly feature sequence based on the session assembly data;
obtaining an assembly sequence requirement and a workstation rated parameter of a workstation from the data center;
generate, through a generation layer of a parameter generation model, a candidate assembly scheme based on the assembly feature sequence, the initial assembly scheme, the assembly sequence requirement, and the workstation rated parameter; the parameter generation model being a machine learning model;
determine, through an evaluation layer of the parameter generation model, a production scoring parameter of the candidate assembly scheme based on the candidate assembly scheme, environmental data, material data, historical energy consumption data, and a device parameter; and
determine the optimized assembly scheme based on the production scoring parameter and a condition parameter.

12. The assembly optimization system of claim 11, wherein the parameter generate model is obtained by training based on a training sample dataset, a training process of the parameter generation model includes an initial training phase and an intensive training phase; wherein training samples of the training sample dataset include first training samples, second training samples, first labels corresponding to the first training samples, and second labels corresponding to the second training samples;
the first training samples are applied to train the generation layer, the first training samples include a sample assembly feature sequence, a sample initial assembly scheme, a sample assembly sequence requirement, and a sample workstation rated parameter, and the first labels include available assembly schemes corresponding to the first training samples;
the second training samples are applied to train the evaluation layer, the second training samples include a sample assembly scheme, sample environmental data, sample material data, sample energy consumption data, and a sample device parameter, and the second labels include actual acquired production scoring parameters corresponding to the second training samples;
in the initial training phase, the training sample datasets is obtained based on a general dataset on a cloud platform;
in the intensive training phase, the training sample dataset is obtained based on historical data actually collected in a plant, and a proportion of samples corresponding to a fault type is not less than a preset threshold; and
the preset threshold is positively correlated with a loss cost corresponding to the fault type.

13. The assembly optimization system of claim 12, wherein the second training samples and the second labels are obtained based on simulation data.

14. The assembly optimization system of claim 11, wherein the IIoT management platform is further configured to:
determine a first optimization session through an optimization session determination model based on the assembly feature sequence, the workstation rated parameter, the device parameter, and historical session assembly data; the optimization session determination model being a machine learning model; and
determine the candidate assembly scheme based on the first optimization session.

15. The assembly optimization system of claim 11, wherein an input of the generation layer of the parameter generation model further includes a first optimization session.

16. The assembly optimization system of claim 10, wherein the determining a target assembly scheme based on the optimized assembly scheme includes:
obtaining simulated assembly data and simulated production data corresponding to the optimized assembly scheme by simulating the production line based on a preset simulation parameter and the optimized assembly scheme, the preset simulation parameter including a simulated intensity sequence;
determining a simulated feature sequence based on the simulated assembly data;
determining, based on the simulated features sequence and the assembly feature sequence, an optimization validity sequence corresponding to the optimized assembly scheme; and
determining the target assembly scheme based on the optimization validity sequence, the simulated production data, and the optimized assembly scheme.

17. The assembly optimization system of claim 16, wherein the preset simulation parameter is positively correlated with a session complexity parameter;
the session complexity parameter is determined based on a workstation rated parameter, a component interconnection, an assembly component object, and a process difficulty factor.

18. The assembly optimization system of claim 7, wherein the IIoT management platform is further configured to:
determine a second optimization session based on the optimization validity sequence and a validity threshold; and
determine an updated target assembly scheme by updating the target assembly scheme based on the second optimization session.

19. A non-transitory computer-readable storage medium comprising computer instructions that, when read by a computer, direct the computer to perform the assembly optimization method of claim 1.
